(19) United States
(12) Patent Application Publication
(10) Pub. No.: US 2021/0274762 A1
(43) Pub. Date: Sep. 9, 2021

(54) FISHING LURE

(71) Applicant: GLOBERIDE, Inc., Tokyo (JP)

(72) Inventors: Hiroshi Yagi, Tokyo (JP); Kenichi Wakabayashi, Tokyo (JP)

(21) Appl. No.: 17/192,953

(22) Filed: Mar. 5, 2021

(30) Foreign Application Priority Data
Mar. 6, 2020 (JP) 2020-038754
Mar. 6, 2020 (JP) 2020-038755

(51) Int. Cl. A01K 85/12; A01K 95/00

(52) U.S. Cl. CPC A01K 85/12; A01K 95/00

(57) ABSTRACT

A fishing lure includes: a main body portion with a cavity provided inside of the main body portion; a support member having an end portion attached to the main body portion; and a swing member that swings and is supported by the support member. The swing member is visible from the outside of the main body portion. At least a part of the swing member is formed to be in a circular shape, a polygonal shape, a corrugated shape, or a star shape in a cross section orthogonal to an extending direction of the swing member. Another fishing lure includes: a main body portion with a cavity provided inside of the main body portion; a magnet provided to the main body portion; a support member having an end portion supported by the main body portion; and a swing member that swings and is supported by the support member. The swing member is visible from the outside of the main body portion. A magnetic body is provided at a position facing the magnet of the swing member.

### TECHNICAL FIELD

This disclosure relates to a fishing lure.

### BACKGROUND

Conventionally, an artificial bait (lure) replicating bait such as a small fish has been used in lure fishing for catching fish (fish eaters). Various types of such a lure have been known including a bait log, spoon, plug, spinner, jig, plastic lure and the like.

As one such lure, JP-A-Hei 11-75628 relates to a fish lure such as an artificial bait used for fishing. Particularly, the fish lure includes a main body in which a light beam reflecting object is sealed together with liquid. The movement of the reflecting object leads to complex reflected light, producing better catches.

The fish lure disclosed in JP-A-Hei 11-75628 requires a large space for sealing a small light reflecting piece together with liquid. Unfortunately, such a space might be difficult to secure in the first place, depending on the size of the lure. Furthermore, while the fish lure as disclosed in JP-A-Hei 11-75628 does feature the reflection of light, the reflected light might not reach fish eaters depending on the incident angle of the external light on the small piece, meaning that the fish luring effect is not necessarily high. Still, furthermore, the fish lure disclosed in JP-A-Hei 11-75628 simply has the light reflecting small piece sealed together with liquid, and the movement of the small piece itself is difficult to control.

It could therefore be helpful to provide a lure including a luring mechanism with which a fish eater can be more reliably lured using a smaller space, and a lure including a luring mechanism that can be more reliably controlled using a smaller space.

### SUMMARY

We thus provide:

A fishing lure comprises: a main body portion with a cavity provided inside of the main body portion; a support member having an end portion supported by the main body portion; and a swing member that swings and is supported by the support member, wherein the swing member is visible from outside of the main body portion, and has at least a portion formed to be in a circular shape, a polygonal shape, a corrugated shape, or a star shape as viewed in a cross section orthogonal to an extending direction of the swing .

The swing member may reflect light from the outside.

The at least a portion of the swing member may be formed to be a cylinder, a corrugated shape, a polygonal body, a polyhedral body, or a spherical body.

The support member may support the swing member at a center position of the swing member or a position separated from the center position, as viewed in the cross section orthogonal to the extending direction of the swing member.

The swing member may be supported by the support member via a ball bearing.

The swing member may be supported by the support member via a spring member.

The support member may be formed in a cylindrical shape.

The support member may comprise one or a plurality of eyes.

The swing member may comprise one or a plurality of swing portions.

The swing member may be provided with a weight.

A fishing lure includes: a main body portion with a cavity provided inside of the main body portion; a magnet provided to the main body portion; a support member having an end portion supported by the main body portion; and a swing member that swings and is supported by the support member, wherein the swing member is visible from outside of the main body portion, and a magnetic body is provided at a position of the swing member facing the magnet.

The magnet may be provided in an upper portion of the main body portion.

The magnet may be provided at two or more positions facing the magnetic body.

The magnet may comprise two magnets provided to the main body portion to face each other.

The swing member may reflect light from the outside.

The swing member may have at least a portion formed to be in a circular shape, a polygonal shape, a corrugated shape, or a star shape as viewed in a cross section orthogonal to an extending direction of the swing member.

The at least a portion of the swing member may be a cylinder, a corrugated shape, a polygonal body, a polyhedral body, or a spherical body.

The support member may support the swing member at a center position of the swing member or a position separated from the center position, as viewed in the cross section orthogonal to the extending direction of the swing member.

The support member may be formed in a cylindrical shape.

The swing member may comprise one or a plurality of swing portions.

A lure including a luring mechanism can be provided with which a fish eater can be more reliably lured using a smaller space. A lure including a luring mechanism can be provided that can be more reliably controlled using a smaller space.

### BRIEF DESCRIPTION OF THE DRAWINGS

FIGS. 1A to 1D are sectional views of a swing member of a fishing lure according to one example.

FIG. 2 is a schematic view of a fishing lure according to one example.

FIG. 3 is a diagram illustrating a supporting structure for the swing member of a fishing lure according to one example.

FIG. 4 is a diagram illustrating a supporting structure for the swing member of a fishing lure according to one example.

FIG. 5 is a diagram illustrating a supporting structure for the swing member of a fishing lure according to one example.

FIG. 6 is a diagram illustrating a supporting structure for the swing member of a fishing lure according to one example.

FIGS. 7A to 7G are perspective views of the swing member of a fishing lure according to one example.

FIGS. 8A to 8C are perspective views of the swing member of a fishing lure according to one example.

FIGS. 9A and 9B are diagrams illustrating a supporting structure for the swing member of a fishing lure according to one example.

FIG. 10 is a schematic view of a fishing lure according to one example.

FIG. 11 is a diagram describing a swing mechanism for a fishing lure according to one example.

FIG. 12 is a diagram describing a swing mechanism for a fishing lure according to one example.

FIG. 13 is a diagram describing a swing mechanism for a fishing lure according to one example.

FIGS. 14A to 14D are sectional views of the swing member of a fishing lure according to one example.

FIGS. 15A to 15G are perspective views of the swing member of a fishing lure according to one example.

FIGS. 16A to 16C are perspective views of the swing member of a fishing lure according to one example.

FIG. 17 is a diagram illustrating a supporting structure for the swing member of a fishing lure according to one example.

### REFERENCE SIGNS LIST

1 lure
2 main body portion
3 support member
4 swing member
5 support receiving portion
6 end portion
7 weight
11 cavity
12 magnet
13 magnet
14 magnetic body (magnet)
15 ball bearing
16 eye
17 spring member
22 upper portion
23 lower portion
24 left side portion
25 right side portion

### DETAILED DESCRIPTION

Various examples of our fishing lures will be described with reference to the drawings as appropriate. Like components in the drawings are denoted by like reference signs.

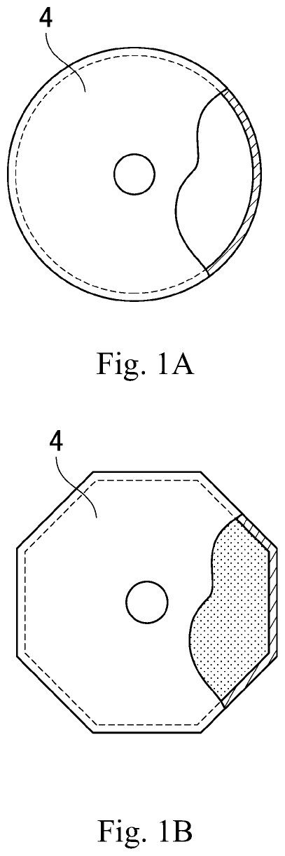

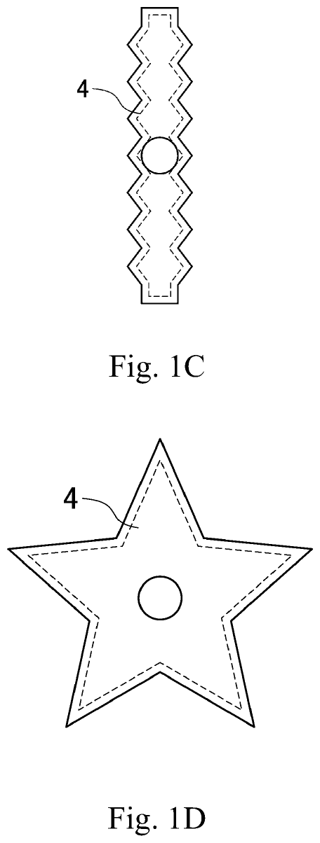

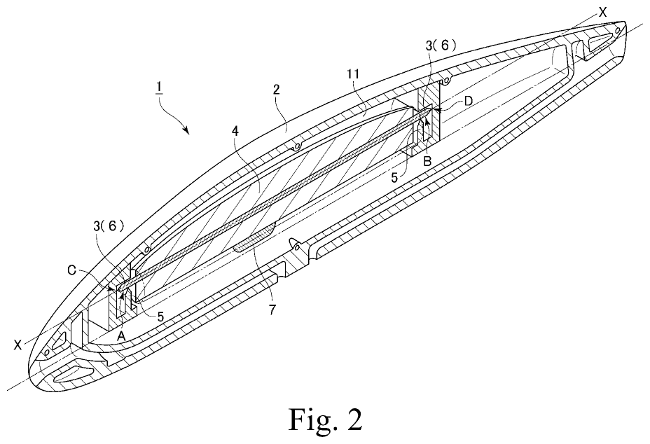

A fishing lure 1 according to one example will be described with reference to FIGS. 1A-1D and 2. As illustrated in FIGS. 1A-1D and 2, the fishing lure 1 includes: a main body portion 2 with a cavity 11 provided inside of the main body portion 2; a support member 3 having an end portion 13 supported by the main body portion 2; and a swing member 4 that swings and is supported by the support member 3. The swing member 4 is visible from the outside of the main body portion 2. At least a part of the swing member 4 is formed to be in a circular shape (FIG. 1A), a polygonal shape (FIG. 1B), a corrugated shape (FIG. 1C), or a star shape (FIG. 1D) in a cross section orthogonal to an extending direction X of the swing member 4. The swing member reflects light from the outside. In the example illustrated in FIG. 2, the swing member 4 is provided with a weight 7 so that the swing (swinging) of the swing member 4 can be maintained for a longer period of time. The support member 3 may be integrally formed with the swing member 4. In such a configuration, the support member 3 and the swing member 4 may both be a resin molded member.

As the material of the swing member 4, a resin, a metal or the like may be used (but is not limited to them). Considering the weight of the lure as a whole, a foam body may be used as an intermediate layer or an inner layer as appropriate. Furthermore, considering the weight of the lure as a whole, the swing member 4 may have an unnecessary portion removed or may be hollow as appropriate.

A lure including a luring mechanism can be provided with which a fish eater can be more reliably lured using a smaller space. More specifically, the swing member 4 can rotate about the support member 3. Thus, the swing member 4 has a movable range limited while being prevented from colliding with an inner portion of the main body portion, whereby the cavity can have the smallest possible space. Light received from the outside by the swing member 4 can be reflected in various directions so that the reflected light reliably reaches the fish eater, whereby the luring effect can be dynamically improved.

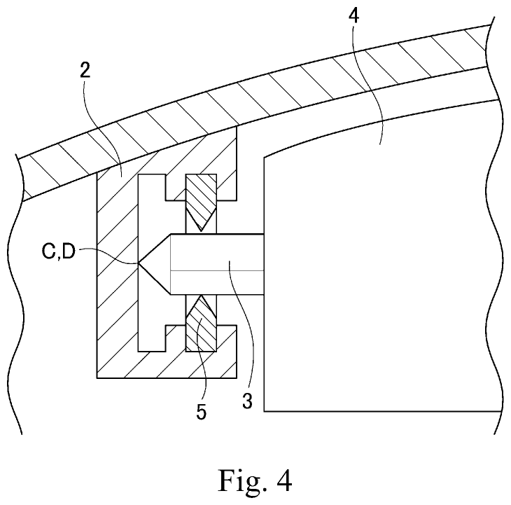

The fishing lure 1 according to one example will be described more in detail with reference to FIGS. 2, 3, and 4. The swing member 4 is supported by the support member 3, and in the illustrated example, the support member 3 is supported by support receiving portions 5 provided to the main body portion 2. As illustrated in the figure, the support member 3 may have end portions A and B in the lateral direction in the drawing sheet as well as end portions C and D in the vertical direction in the drawing sheet formed to be tapered toward the distal ends (protruding shape). With this configuration, the swing member 4 can swing in response to a slight movement of the lure and for a longer period of time.

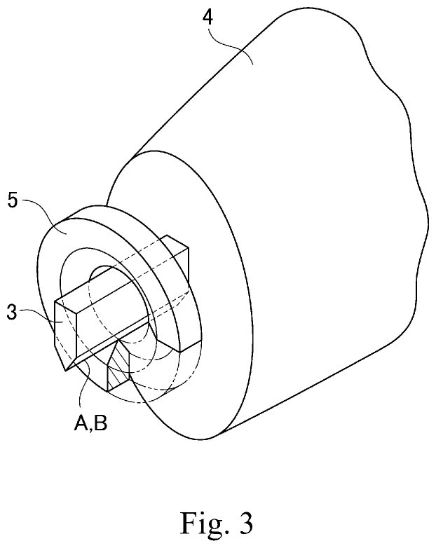

As illustrated in FIGS. 2 and 3, the support receiving portion 5 provided to the main body portion 2 may be formed to have sharp distal ends. With this configuration, the support receiving portion 5 can make the swing member 4 swing via the support member 3 in response to a slight movement of the lure, stronger and for a longer period of time.

The shapes of the support member 3 and the support receiving portion 5 illustrated in FIGS. 2, 3 and 4 are exemplary, and there may be various possible modes (such as a cylindrical shape, for example) other than these. Thus, the shapes are not limited to a specific mode.

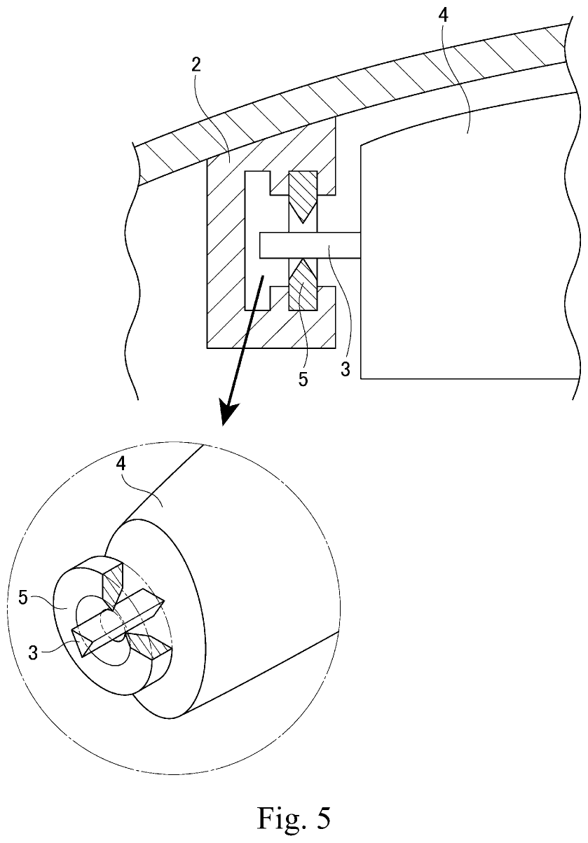

FIG. 5 illustrates another example of the support receiving portion 5. In the illustrated example, the support receiving portion 5, provided separately from the main body portion 2, is formed as a ring shaped member with an inner side surface having a protruding shape. In this example, the support member 3 (with a triangular cross section in the non-limiting illustrated example) is provided through the support receiving portion 5 to be supported by the inner side surfaces of the support receiving portion 5. The support receiving portion 5 may be formed by a metal or a resin. With this configuration, the swing member 4 can swing in response to a slight movement of the lure and for a longer period of time.

FIG. 6 illustrates another example of the support receiving portion 5. In the illustrated example, the main body portion 2 is provided with a ball bearing 15 to rotatably support the support member 3. With this configuration, the swing member 4 can swing in response to a slight movement of the lure and for a longer period of time.

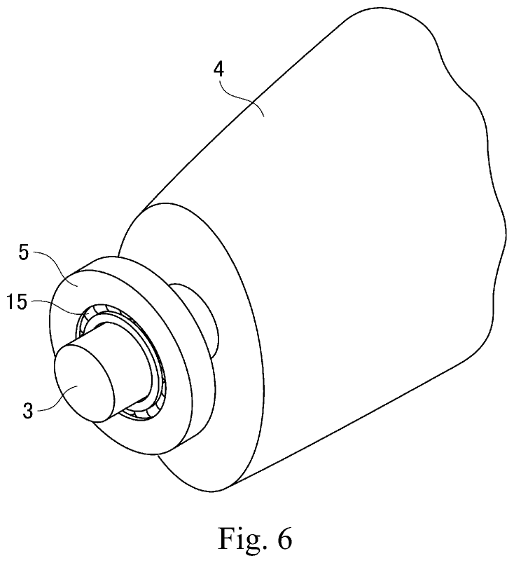

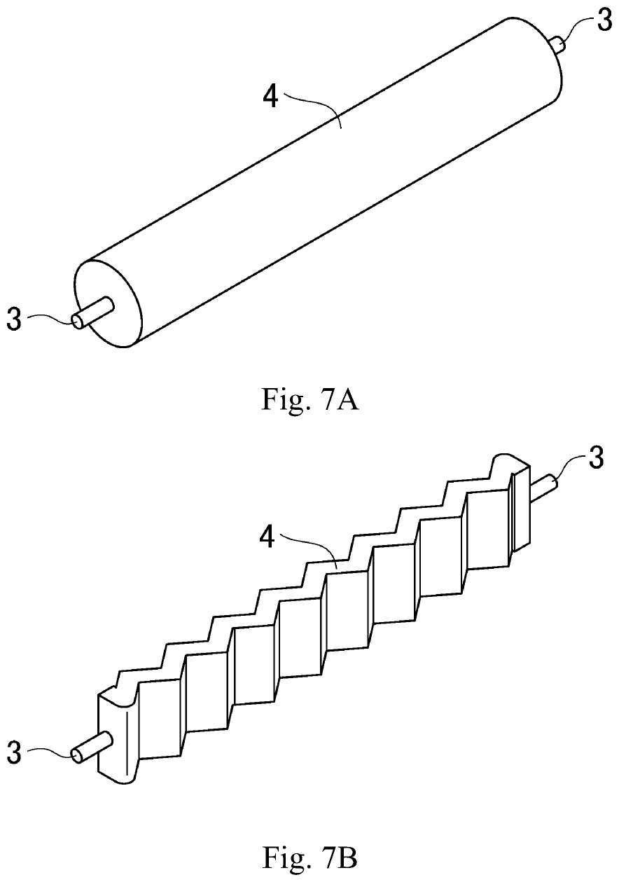

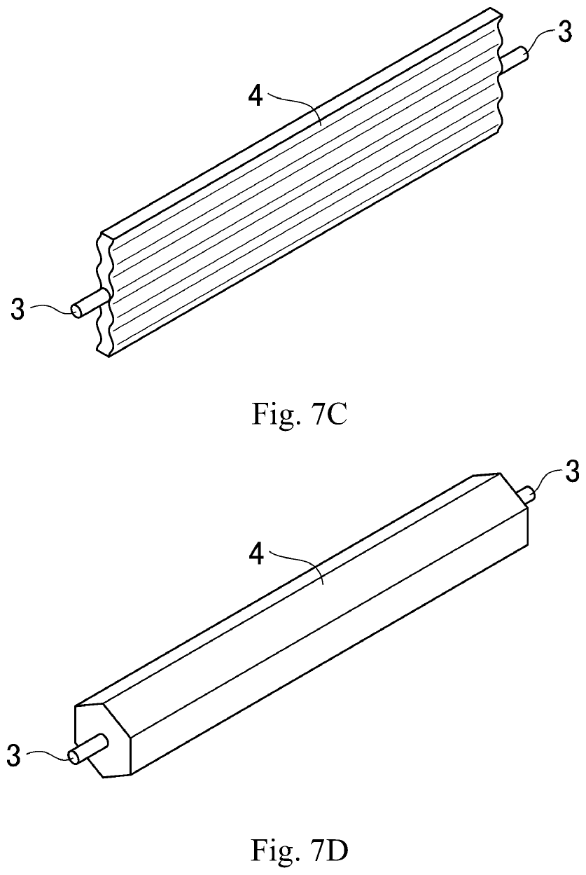

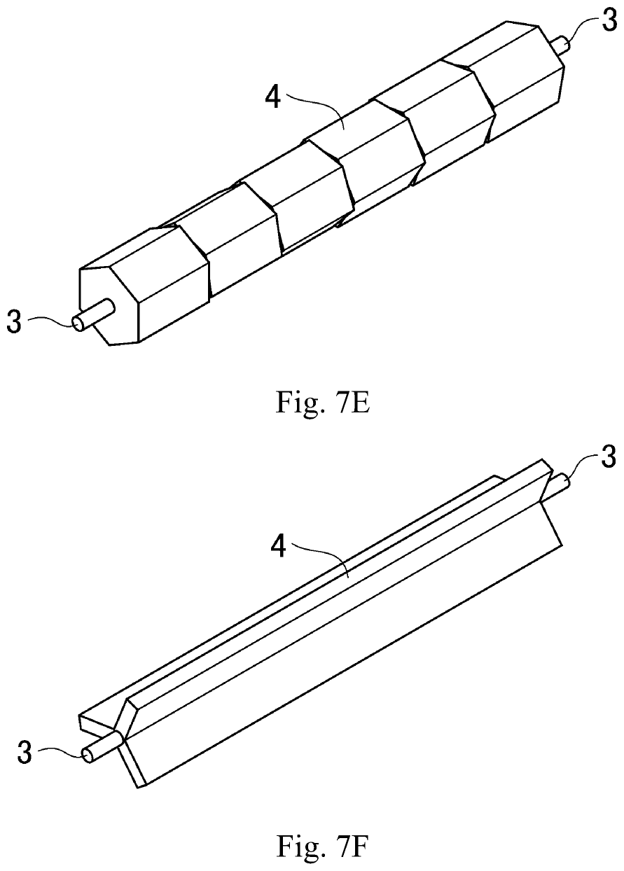

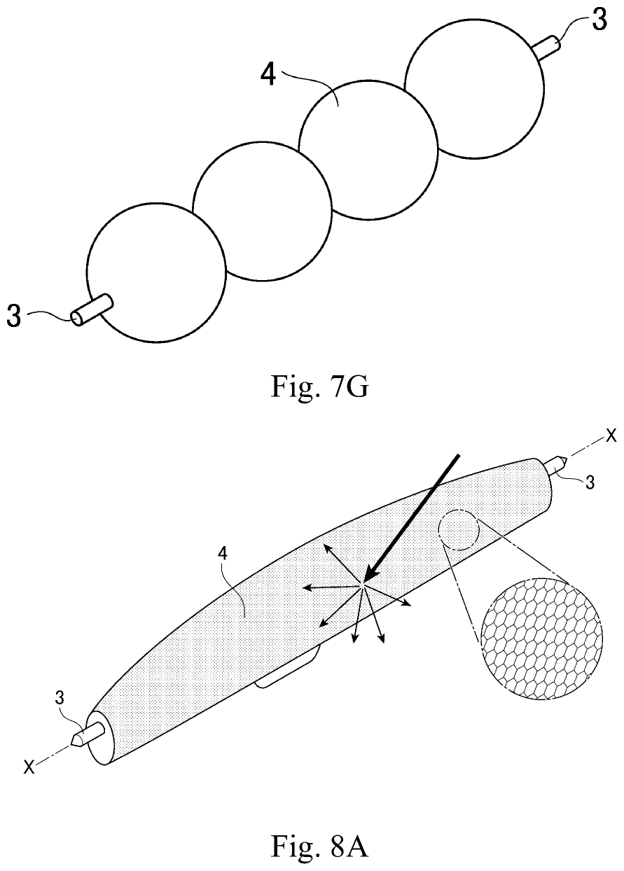

Next, the swing member 4 of the fishing lure 1 according to one example will be described with reference to FIGS. 7A-7G. The swing member 4 (or may be at least a part of the swing member 4) may be formed to be in a cylindrical shape (FIG. 7A), a corrugated shape (FIGS. 7B and 7C), a polygonal shape (including a mode configured by a plurality of polygonal members) (FIGS. 7D and 7E), a polyhedral shape (including a propeller-shaped mode) (FIG. 7F), and a spherical body (FIG. 7G). With this configuration, a lure including a luring mechanism can be provided with which light can be reflected to multiple directions with a smaller space so that fish eaters can be more reliably lured.

More specifically, the swing member 4 can rotate about the support member 3. Thus, the swing member 4 has a movable range limited while being prevented from colliding with an inner portion of the main body portion, whereby the cavity can have the smallest possible space. Light received from the outside by the swing member 4 can be reflected in various directions so that the reflected light reliably reaches the fish eater, whereby the luring effect can be dynamically improved.

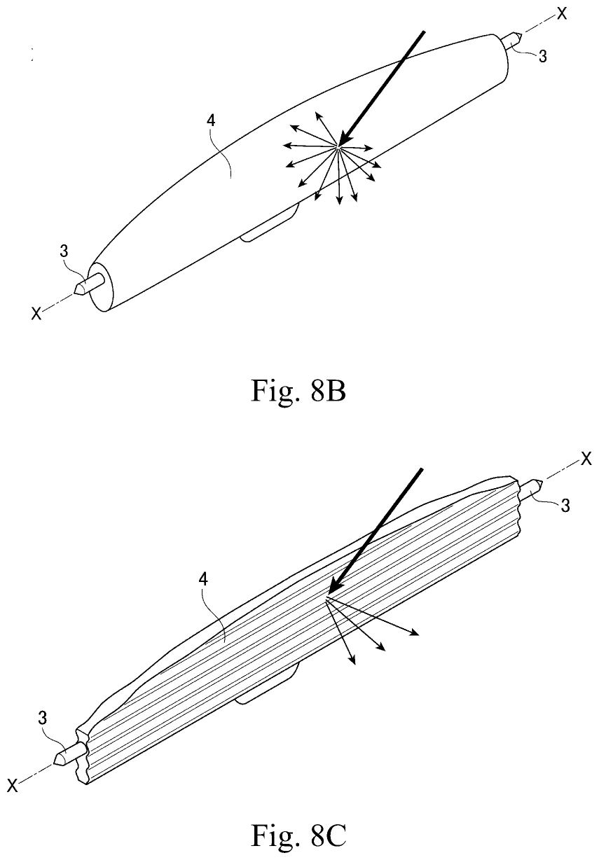

Next, the fishing lure 1 according to one example will be described with reference to FIGS. 8A-8C. The support member 3 is configured to support the swing member 4 at the center position (modes in FIGS. 7A-7G) of the swing member 4, or at a position (modes in FIGS. 8A-8C) separated from the center position, as viewed in a cross section orthogonal to the extending direction X of the swing member 4.

FIG. 8A illustrates the fishing lure 1 according to one example in which the swing member 4, supported by the support member 3, has a shape similar to a football and is formed to be a polygonal body as a whole. With the position of the swing member 4 supported by the support member 3 thus separated from the center position, the swing member 4 can reliably swing with the lowest possible risk of colliding with the inner portion of the main body portion. With the swing member 4 formed into a polygonal body, the light received by the swing member 4 from the outside can be reflected to various directions so that the reflected light reliably reaches the fish eater, whereby the luring effect can be dramatically increased.

Next, FIG. 8B illustrates the fishing lure 1 in which the swing member 4, supported by the support member 3, has a substantially football shape and has a hologram attached to its surface. As in FIG. 8A, with the position of the swing member 4 supported by the support member 3 separated from the center position, the swing member 4 can reliably swing with the lowest possible risk of colliding with the inner portion of the main body portion. With the hologram attached to the swing member 4, as in the polygonal body in FIG. 8A, the light received by the swing member 4 from the outside can be reflected to various directions so that the reflected light reliably reaches the fish eater, whereby the luring effect can be dramatically increased.

Next, FIG. 8C illustrates the fishing lure 1 in which the swing member 4, supported by the support member 3, is formed to be in a corrugated shape. As in FIGS. 8A and 8B, with the position of the swing member 4 supported by the support member 3 separated from the center position, the swing member 4 can reliably swing with the lowest possible risk of colliding with the inner portion of the main body portion. With the swing member 4 formed to be in the corrugated shape, as in FIGS. 8A and 8B, the light received by the swing member 4 from the outside can be reflected to various directions so that the reflected light reliably reaches the fish eater, whereby the luring effect can be dramatically increased.

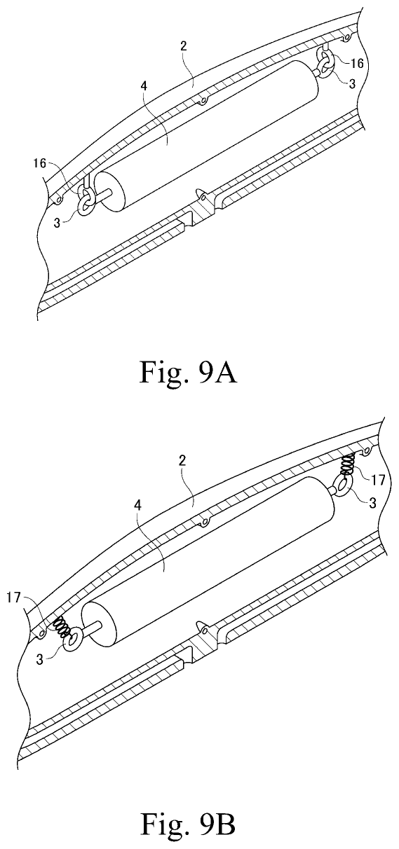

Next, a supporting structure for the swing member 4 of the fishing lure 1 according to one example will be described with reference to FIGS. 9A and 9B. FIG. 9A illustrates a fishing lure in which the support member 3 is connected to the main body portion of one or a plurality of eyes 16. Thus, the eye 16 can be effectively used for supporting the swing member 4.

FIG. 9B illustrates the fishing lure in which the support member 3 is connected to the main body portion 2 by a spring member 17. The swing member 4 thus supported by the spring member 17 can more reliably swing.

In any of the configurations illustrated in FIGS. 9A and 9B, smoother swing (swinging) can be achieved with a contact portion of the eye 16 formed to be in a knife edge shape (sharp edge shape).

In the modes described above, the swing member 4 may be configured to include a plurality of swing portions. In this example, one or a plurality of support members 3 may be configured to support the swing member 4. With this configuration, the plurality of swing portions of the swing member 4 can reflect light received from the outside to various direction so that the reflected light reliably reaches the fish eater, whereby the luring effect can be dramatically increased.

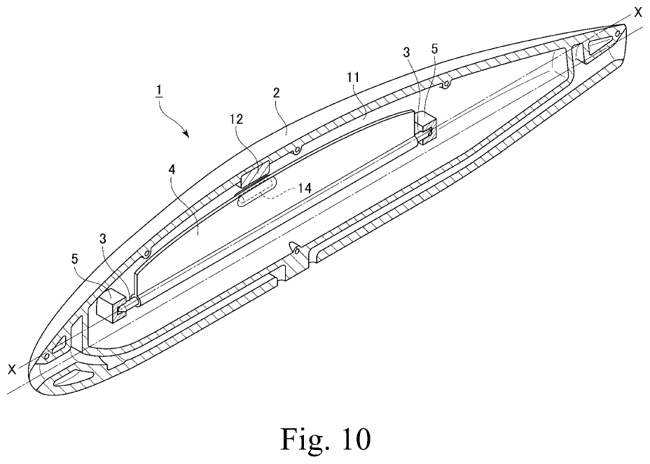

The fishing lure 1 according to one example will be described with reference to FIG. 10. As illustrated in FIG. 10, the fishing lure 1 includes: a main body portion 2 with a cavity 11 provided inside of the main body portion; a magnet 12 provided to the main body portion 2; a support member 3 having an end portion supported by the main body portion 2; and a swing member 4 that swings and is supported by the support member 3. The swing member 4 is visible from the outside of the main body portion 2. A magnetic body (magnetic material) 14 is provided at a position of the swing member 4 facing the magnet 12. The swing member 4 is configured to reflect light from the outside. As the material of the swing member 4, a resin, a metal or the like may be used but is not limited to these.

A lure including a luring mechanism can be provided that can be more reliably controlled using a smaller space.

More specifically, rotation of the swing member 4 can be controlled by the magnetic force of the magnet 12 due to the magnetic body 14 provided to the swing member 4. Thus, the swing member 4 has a movable range limited while being prevented from colliding with an inner portion of the main body portion, whereby the cavity can have the smallest possible space. Furthermore, with the magnetic body 14 provided to the swing member 4, the swing member 4 can smoothly and continuously rotate due to the magnetic force of the magnet 12. Thus, light received from the outside by the swing member 4 can be reflected in various directions so that the reflected light reliably reaches the fish eater, whereby the luring effect can be dynamically improved.

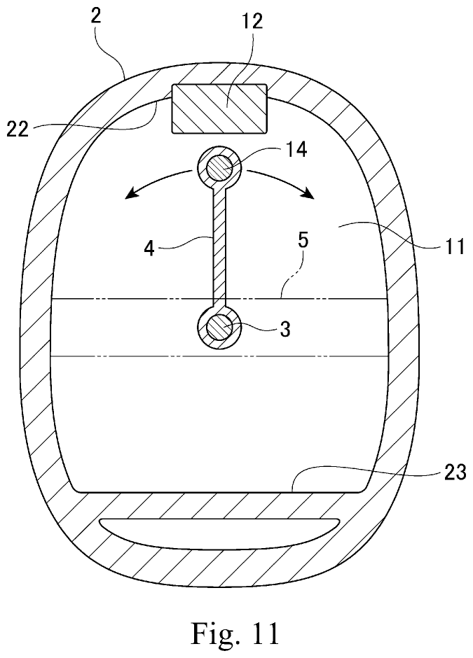

Next, the fishing lure 1 according to one example will be described with reference to FIG. 11. FIG. 11 illustrates the fishing lure 1 according to one example in which the swing member 4 is supported by the support member 3 and has one end provided with the magnetic body 14, and the magnet 12 is configured to be provided in an upper portion 22 of the main body portion 2. The support member 3 may be formed by an elastic material, and may be coupled to the main body portion 2 using the same material. A plurality of the magnets 12 may be provided (the same applies to the following). Furthermore, a plurality of the magnetic bodies 14 may be provided (the same applies to the following). The upper portion 22 of the main body portion 2 corresponds to an upper side of the drawing sheet in FIG. 11. Alternatively, the magnet 12 may be provided in a lower portion 23 of the main body portion 2. The lower portion 23 of the main body portion 2 corresponds to a lower side of the drawing sheet in FIG. 11.

The swing member 4 can swing left and right, with the magnetic body 14 of the swing member 4 being attracted to the magnet 12 of the main body portion 2, whereby the lure including the luring mechanism can be provided that can be more reliably controlled with a smaller space.

More specifically, rotation of the swing member 4 can be controlled by the magnetic force of the magnet 12 due to the magnetic body 14 provided to the swing member 4. Thus, the swing member 4 has a movable range limited while being prevented from colliding with an inner portion of the main body portion, whereby the cavity can have the smallest possible space. Furthermore, with the magnetic body 14 provided to the swing member 4, the swing member 4 can smoothly and continuously rotate due to the magnetic force of the magnet 12. Thus, light received from the outside by the swing member 4 can be reflected in various directions so that the reflected light reliably reaches the fish eater, whereby the luring effect can be dynamically improved.

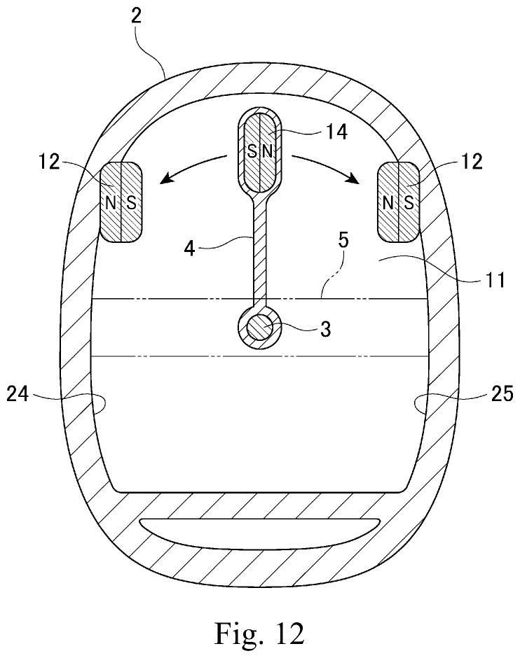

Next, the fishing lure 1 according to one example described with reference to FIG. 12. The magnets 12 are provided at two or more positions facing the magnetic body 14. As illustrated in FIG. 12, the two magnets 12 are provided to the main body portion 2 to face each other. A left side portion 24 and a right side portion 25 of the main body portion 2 are each provided with a single magnet 12, but may be provided with two or more magnets 12. The left side portion 24 and the right side portion 25 of the main body portion 2 respectively correspond to the left and the right sides of the drawing sheet in FIG. 12.

The swing member 4 can swing left and right with the S and N poles of the magnetic body 14 of the swing member 4 respectively pushed away from the S pole of one magnet 12 of the main body portion 2 and the N pole of the other magnet 12, whereby the lure including the luring mechanism can be provided that can be more reliably controlled with a smaller space.

More specifically, the swing member 4 can rotate about the support member 3, and rotation of the swing member 4 can be controlled by the magnetic force of the magnets 12 provided on both sides due to the magnetic body 14 provided to the swing member 4. Thus, the swing member 4 has a movable range limited while being prevented from colliding with an inner portion of the main body portion, whereby the cavity can have the smallest possible space. Furthermore, with the magnetic body 14 provided to the swing member 4, the swing member 4 can smoothly and continuously rotate due to the magnetic force of the magnets 12. Thus, light received from the outside by the swing member 4 can be reflected in various directions so that the reflected light reliably reaches the fish eater, whereby the luring effect can be dynamically improved.

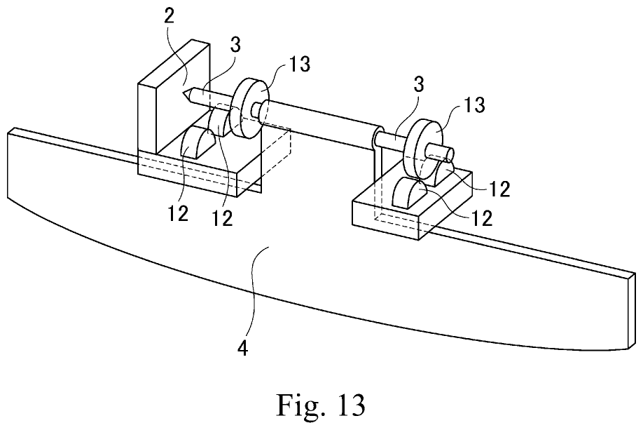

Next, a fishing lure 1 according to another example will be described with reference to FIG. 13. As illustrated in FIG. 13, two magnets 13 provided to the support member 3 supporting the swing member 4 float due to four magnets 12 provided to the main body portion 2. With this configuration in which the two magnets 13 provided to the support member 3 supporting the swing member 4 float due to the four magnets 12 provided to the main body portion 2, the support member 3 can move in the upward and downward direction and in the left and right direction so that the swing member 4 supported by the support member 3 can swing, whereby the lure including the luring mechanism can be provided that can be reliably controlled with a smaller space.

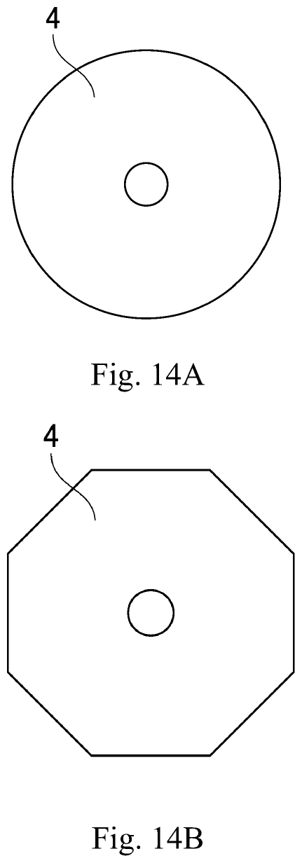

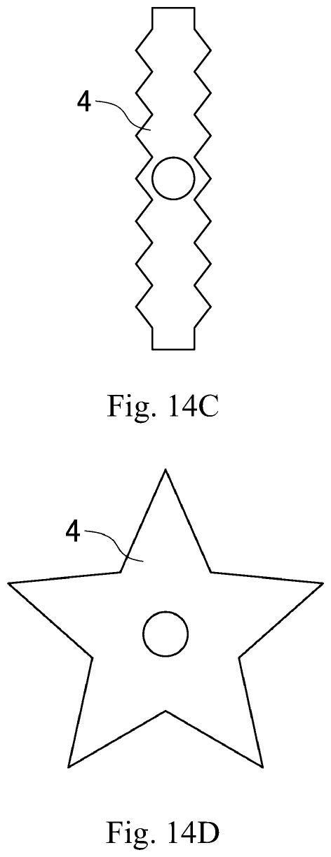

Next, the swing member 4 of the fishing lure 1 according to one example will be described with reference to FIGS. 14A-14D. As illustrated in FIGS. 14A-14D, the fishing lure 1 according to one example includes the swing member 4 that is visible from the outside of the main body portion 2. At least a part of the swing member 4 is formed to be in a circular shape (FIG. 14A), a polygonal shape (FIG. 14B), a corrugated shape (FIG. 14C), or a star shape (FIG. 14D) in a cross section orthogonal to the extending direction X (see FIG. 10) of the swing member 4.

With this configuration, the swing member 4 can rotate about the support member 3. Thus, the swing member 4 has a movable range limited while being prevented from colliding with an inner portion of the main body portion, whereby the cavity can have the smallest possible space. Furthermore, the light received by the swing member 4 from the outside can be reflected to various directions so that the reflected light reliably reaches the fish eater, whereby the luring effect can be dramatically increased.

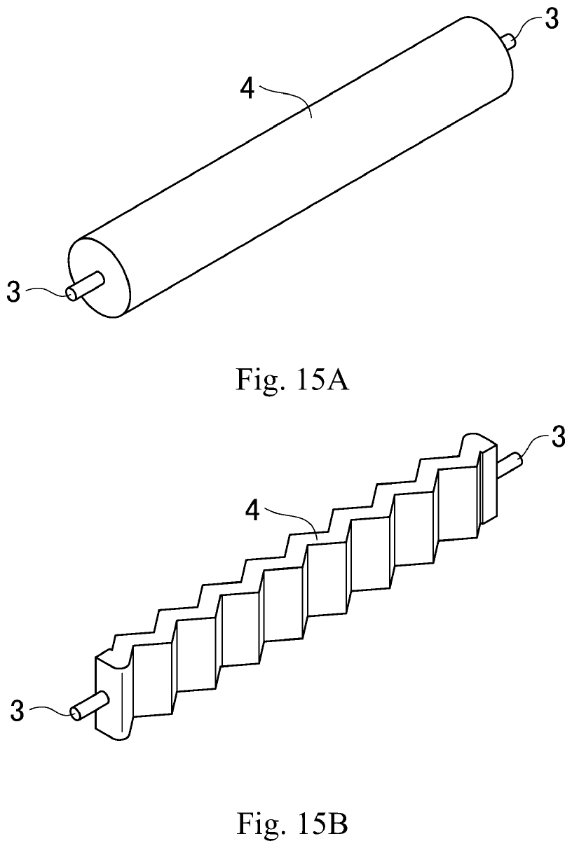

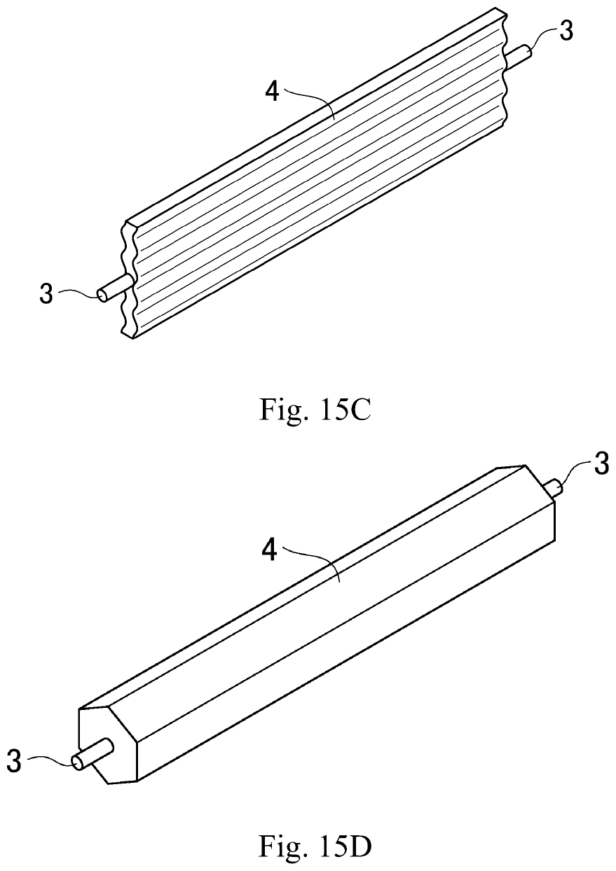

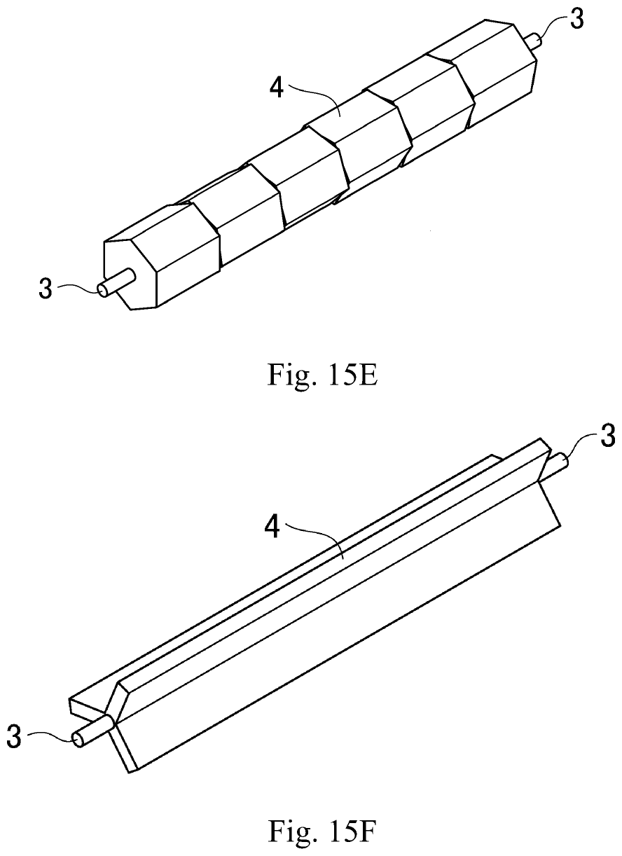

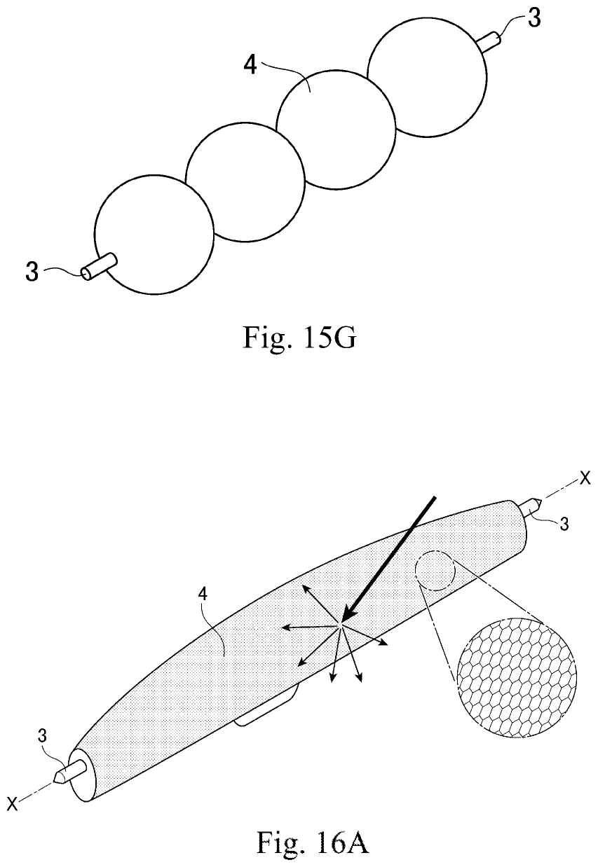

Next, the swing member 4 of the fishing lure 1 according to one example will be described with reference to FIGS. 15A-15G. The swing member 4 (or may be at least a part of the swing member 4) may be formed to be in a cylindrical shape (FIG. 15A), a corrugated shape (FIGS. 15B and 15C), a polygonal shape (including a mode configured by a plurality of polygonal members) (FIGS. 15D and 15E), a polyhedral shape (including a propeller-shaped mode) (FIG. 15F), and a spherical body (FIG. 15G). With this configuration, a lure including a luring mechanism can be provided with which fish eaters can be more reliably lured with a smaller space.

With this configuration, the swing member 4 can rotate about the support member 3. Thus, the swing member 4 has a movable range limited while being prevented from colliding with an inner portion of the main body portion, whereby the cavity can have the smallest possible space. Furthermore, the light received by the swing member 4 from the outside can be reflected to various directions so that the reflected light reliably reaches the fish eater, whereby the luring effect can be dramatically increased.

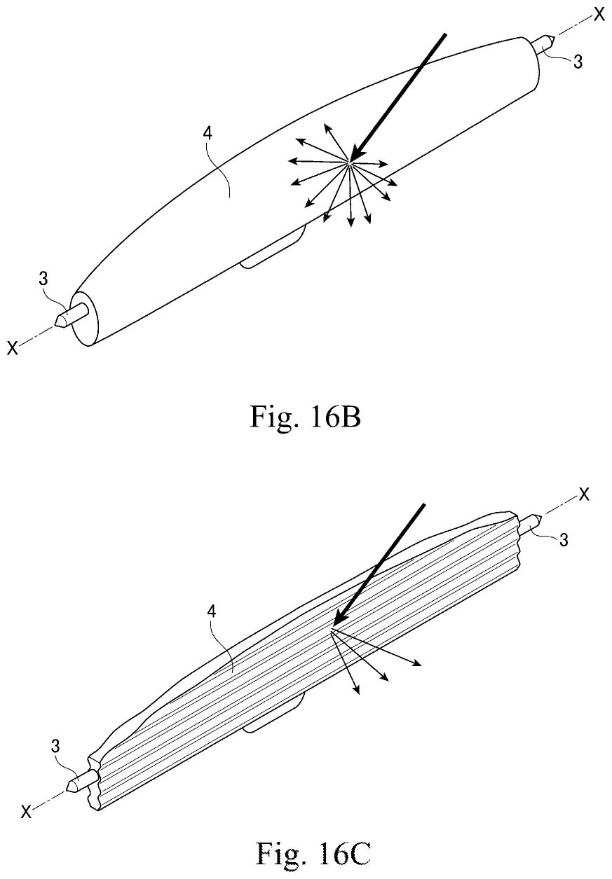

Next, the fishing lure 1 according to one example will be described with reference to FIGS. 16A-16C. The support member 3 is configured to support the swing member 4 at the center position (modes in FIGS. 15A-15G) of the swing member 4, or at a position (modes in FIGS. 10 and 16A-16C) separated from the center position, as viewed in a cross section orthogonal to the extending direction X (see FIG. 10) of the swing member 4.

FIG. 16A illustrates the swing member 4, supported by the support member 3, having a substantially football shape and formed to be a polygonal body as a whole. With the position of the swing member 4 supported by the support member 3 thus separated from the center position, the swing member 4 can reliably swing with the lowest possible risk of colliding with the inner portion of the main body portion. With the swing member 4 formed into a polygonal body, the light received by the swing member 4 from the outside can be reflected to various directions so that the reflected light reliably reaches the fish eater, whereby the luring effect can be dramatically increased.

Next, FIG. 16B illustrates the swing member 4, supported by the support member 3, having a substantially football shape and having a hologram attached to its surface. As in FIG. 16A, with the position of the swing member 4 supported by the support member 3 separated from the center position, the swing member 4 can reliably swing with the lowest possible risk of colliding with the inner portion of the main body portion. With the hologram attached to the swing member 4, as in the polygonal body in FIG. 16A, the light received by the swing member 4 from the outside can be reflected to various directions so that the reflected light reliably reaches the fish eater, whereby the luring effect can be dramatically increased.

Next, FIG. 16C illustrates the swing member 4, supported by the support member 3, formed to be in a corrugated shape. As in FIGS. 16A and 16B, with the position of the swing member 4 supported by the support member 3 separated from the center position, the swing member 4 can reliably swing with the lowest possible risk of colliding with the inner portion of the main body portion. With the swing member 4 formed to be in the corrugated shape, as in FIGS. 16A and 16B, the light received by the swing member 4 from the outside can be reflected to various directions so that the reflected light reliably reaches the fish eater, whereby the luring effect can be dramatically increased.

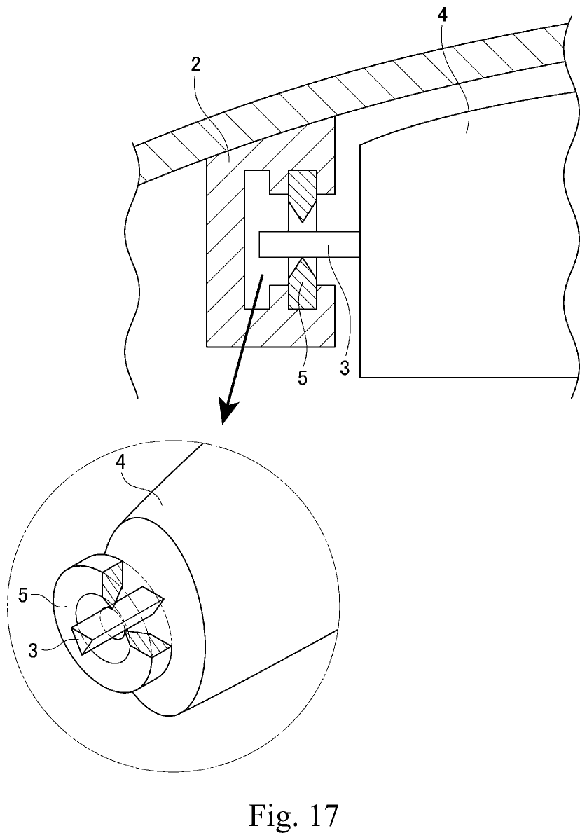

FIG. 17 illustrates another example of the support receiving portion 5. In the illustrated example, the support receiving portion 5, provided separately from the main body portion 2, is formed as a ring shaped member with an inner side surface having a protruding shape. In this example, the support member 3 (with a triangular cross section in the non-limiting illustrated example) is provided through the support receiving portion 5 to be supported by the inner side surfaces of the support receiving portion 5. The support receiving portion 5 may be formed by a metal or a resin. With this configuration, the swing member 4 can swing in response to a slight movement of the lure and for a longer period of time.

Although not illustrated, in another example of the support receiving portion 5, the main body portion 2 may be provided with a ball bearing to rotatably support the support member 3. With this configuration, the swing member 4 can swing in response to a slight movement of the lure and for a longer period of time.

In the modes described above, the swing member 4 may be configured to include a plurality of swing portions. In this example, one or a plurality of support members 3 may be configured to support the swing member 4. With this configuration, the plurality of swing portions of the swing member 4 can reflect light received from the outside to various direction so that the reflected light reliably reaches the fish eater, whereby the luring effect can be dramatically increased.

The dimensions, material, and arrangement of each component described herein are not limited to those explicitly described in the examples, and each of these components can be modified to have any desirable dimensions, material, and arrangement that can fall within the scope of this disclosure. Components that are not explicitly described herein may be added to the described examples, and some of the components described in each example may be omitted.

What is claimed is:

1. A fishing lure comprising:
a main body portion with a cavity provided inside of the main body portion
a support member having an end portion supported by the main body portion; and
a swing member that swings and is supported by the support member and swings, wherein
the swing member is visible from outside of the main body portion, and has at least a portion in a circular shape, a polygonal shape, a corrugated shape, or a star shape as viewed in a cross section orthogonal to an extending direction of the swing member.

2. The lure according to claim 1, wherein the swing member reflects light from the outside.

3. The lure according to claim 1, wherein the at least a portion of the swing member is a cylinder, a corrugated shape, a polygonal body, a polyhedral body, or a spherical body.

4. The lure according to claim 1, wherein the support member supports the swing member at a center position of the swing member or a position separated from the center position, as viewed in the cross section orthogonal to the extending direction of the swing member.

5. The lure according to claim 1, wherein the swing member is supported by the support member via a ball bearing.

6. The lure according to claim 1, wherein the swing member is supported by the support member via a spring member.

7. The lure according to claim 1, wherein the support member is in a cylindrical shape.

8. The lure according to claim 1, wherein the support member comprises one or a plurality of eyes.

9. The lure according to claim 1, wherein the swing member comprises one or a plurality of swing portions.

10. The lure according to claim 1, wherein the swing member is provided with a weight.

11. A fishing lure comprising:
a main body portion with a cavity provided inside of the main body portion
a magnet associated with the main body portion; and
a support member having an end portion supported by the main body portion; and
a swing member that swings and is supported by the support member and swings, wherein
the swing member is visible from outside of the main body portion, and a magnetic body is provided at a position of the swing member facing the magnet.

12. The lure according to claim 11, wherein the magnet is provided in an upper portion of the main body portion.

13. The lure according to claim 11, wherein the magnet is provided at two or more positions facing the magnetic body.

14. The lure according to claim 13, wherein the magnet comprises two magnets that face each other.

15. The lure according to claim 11, wherein the swing member reflects light from the outside.

16. The lure according to claim 11, wherein the swing member has at least a portion in a circular shape, a polygonal shape, a corrugated shape, or a star shape as viewed in a cross section orthogonal to an extending direction of the swing member.

17. The lure according to claim 11, wherein the at least a portion of the swing member is a cylinder, a corrugated shape, a polygonal body, a polyhedral body, or a spherical body.

18. The lure according to claim 11, wherein the support member supports the swing member at a center position of the swing member or a position separated from the center position, as viewed in a cross section orthogonal to the extending direction of the swing member.

19. The lure according to claim 11, wherein the support member is in a cylindrical shape.

20. The lure according to claim 11, wherein the swing member comprises one or a plurality of swing portions.
